(19) United States
(12) Patent Application Publication
(10) Pub. No.: US 2008/0277833 A1
(43) Pub. Date: Nov. 13, 2008

(54) Melamine utensil and manufacturing method thereof

(75) Inventor: Kwo-Chin Chen, PanChiao City (TW)

Correspondence Address: TROXELL LAW OFFICE PLLC, SUITE 1404, 5205 LEESBURG PIKE, FALLS CHURCH, VA, 22041, US

(73) Assignee: SARA ROSE INTERNATIONAL INC.

(21) Appl. No.: 11/798,046

(22) Filed: May 9, 2007

(51) Int. Cl. C08K 5/3432; C08J 5/00

(52) U.S. Cl. 264/331.11; 524/13

(57) ABSTRACT

A melamine utensil and a manufacturing method thereof are disclosed. Melamine powder/particles 10a, wood and/or similar material 30a and over-lay resin 20a are mixed in a certain ratio to form a composite material. Then through a hot pressing process, color or shape of the wood and/or similar material is shown on surface of the utensil so as to increase decorative effect and added value of the melamine utensils. Moreover, strength of the melamine utensils is improved due to wood characters so that the fragileness of general melamine utensils is improved. Furthermore, the weight ratio of the three kinds of material is adjustable for overcoming the shortcoming of easy peeling or crack caused by poor connectivity between the wood and/or similar materials and the melamine powder/particles. In addition, the ratio or depth of color of the wood and/or similar material shown on surface of utensils is also adjustable.

### BACKGROUND OF THE INVENTION

The present invention relates to a melamine utensil and a manufacturing method thereof, especially to a melamine utensil made from composite material formed by melamine powder/particles, powder of wood and/or similar materials, and melamine glazing powder (over-lay resin, LG). Then the mixture goes through a hot pressing process so as to form melamine utensil with wood and/or similar material therein.

Melamine reacts with other materials through addition-condensation reaction and then paper pulp is added into the end products. After being dried and grinding (or coloring), the melamine powder/particles are obtained. The melamine has advantages of easy dyeing, good thermal stability, incombustibility, hardness after curing and shone with gleam so that it has been broadly applied to manufacturing of various containers or utensils such as vessels, cups, dishes, bowls, pots and barrels. Conventional manufacturing method of melamine includes following steps:

Put certain amount of single-color or multiple-color melamine powder/particles material into a disk-shaped container. Then put the container with the melamine material into a heater for preheating the material under about 40 degrees Celsius so as to melt the raw material into a soft green compact. Next put the soft green compact into a mold at the temperature of about 180 degrees Celsius for hot pressing. Then release the shaped melamine utensil from the mold, through cooling and trimming to form a finished melamine utensil. Now a decorative of paper with various marks, colors, or figures thereof is covered on the formed melamine utensils by hot pressing so as to increase varieties and vividness of the utensils. However, conventional melamine utensils have following shortcomings:
(1) the base color of the melamine utensil is the same with that of the melamine powder/particles. Once there are at least two colors of melamine powder/particles mixed together, the material is melt and diffused with each other. The different colors can't be distinguished with one another. Moreover, the attached decorative paper with figures shows quality different from the melamine utensil. The conventional single-colored melamine utensils or utensils with decorative paper is monotonous. And such kind of cheap, mass-produced utensils can't satisfy users requirements any more. Furthermore, the applications and development of melamine utensils are restricted.
(2) Furthermore, although the melamine utensils are quite hard, it's fragile with poor impact resistance. Thus the applications and safety of the melamine utensils are limited.
(3) In addition, the melamine utensils made from melamine powder/particles is quite heavy and is unable to be recycled. Thus they can't satisfy environmental requirements. Therefore, applications and market development of melamine utensils are restricted.

### SUMMARY OF THE INVENTION

Therefore it is a primary object of the present invention to provide a melamine utensil and a manufacturing method thereof that use a composite material formed by melamine powder/particles, powder of wood and/or similar materials, and over-lay resin to replace conventional melamine powder/particles. The composite material is through a hot pressing process so as to make shapes and colors of the wood and/or similar materials show on surface of finished utensils. Thus the decorative effect as well as added value of the melamine utensils is improved.

It is another object of the present invention to provide a melamine utensil and a manufacturing method thereof that uses wood discards and/or similar materials such as bamboo material so as to reduce amount of melamine powder/particles being used. Moreover, strength and robustness of the finished utensils are improved by wood. The utensils are not as fragile as prior arts.

It is a further object of the present invention to provide a melamine utensil and a manufacturing method thereof that use composite material formed by three kinds of material. The weight ratio of the materials is modified according to users needs. For example, weight percentage of the melamine powder/particles ranges from 25 to 40, powder of wood and/or similar materials (such as bamboo) ranges from 40 to 25, and over-lay resin is from 20 to 50. During the hot pressing process, the wood and/or similar materials are adhered to or enclosed by the melamine powder/particles or the over-lay resin so as to prevent the wood and/or similar materials from stripping. Moreover, the ratio or depth of color of the wood and/or similar material shown on surface of utensils can be adjusted.

### BRIEF DESCRIPTION OF THE DRAWINGS

FIG. 1 is a perspective view of an embodiment in accordance with the present invention;

FIG. 2 is a front view of the embodiment in FIG. 1;

FIG. 3 is cross sectional view of the embodiment in FIG. 1;

FIG. 4 is a partial enlarged view of the embodiment in FIG. 3;

FIG. 5 is a schematic drawing showing manufacturing process of the present invention.

### DETAILED DESCRIPTION OF THE PREFERRED EMBODIMENT

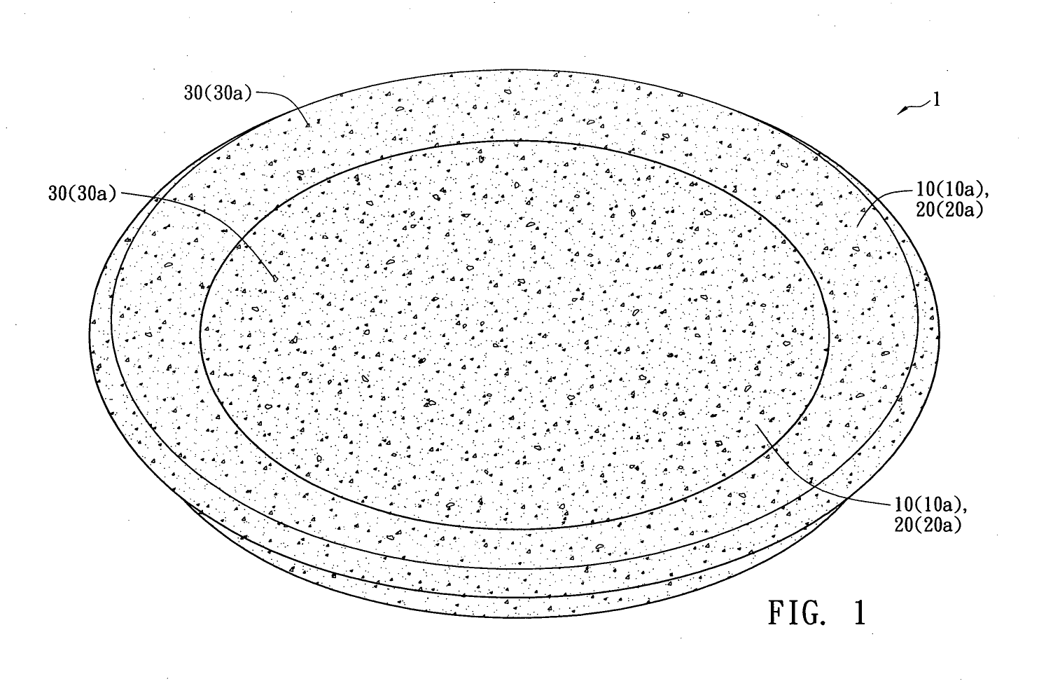

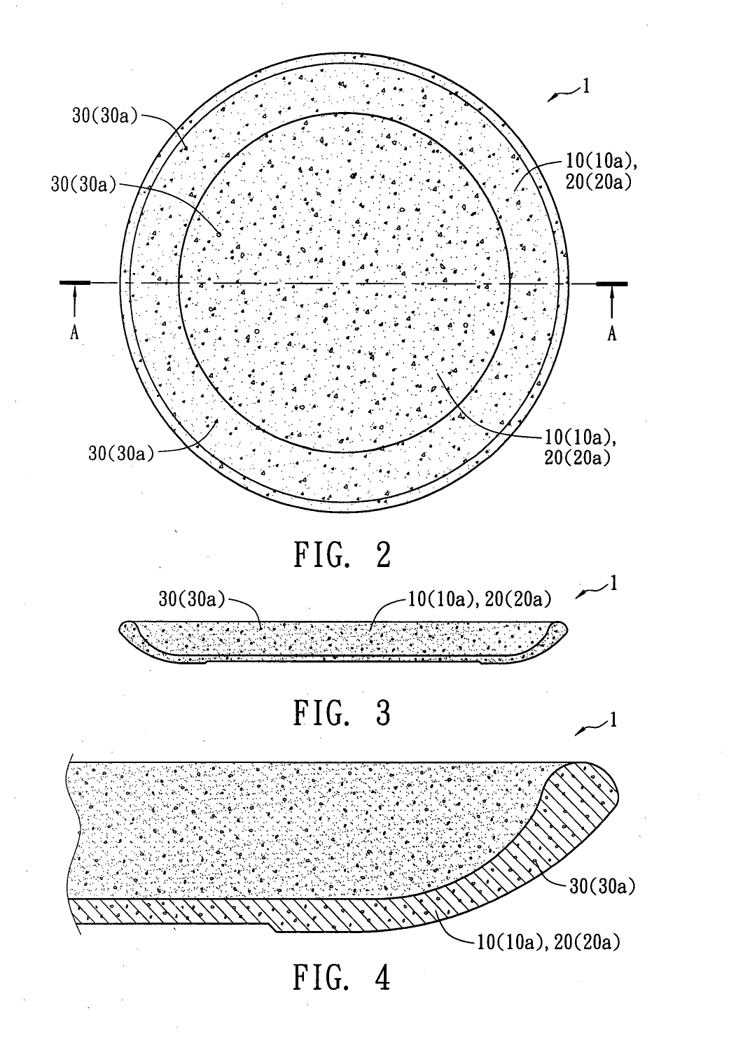

Refer from FIG. 1 to FIG. 5, there is no restriction on the shape of the melamine utensils. The melamine utensil includes a melamine primary material 10 formed by melamine powder/particles 10a through hot pressing, an over-lay resin primary material 20 formed by the hot-pressed over-lay resin 20a and a wood part 30 formed by hot-pressed wood and/or similar materials 30a. The wood and/or similar materials 30a includes wood powder, flake and/or similar materials such as bamboo. Furthermore, the melamine powder/particles 10a and the over-lay resin 20a are melt and integrated so that the melamine primary material 10 and the over-lay resin primary material 20 can't be distinguished, as shown in FIG. 4.

As to the wood and/or similar materials 30a, they can't melt and integrate with melamine powder/particles 10a or the over-lay resin 20a during the hot-pressing process. They only flow freely along with the melt melamine powder/particles 10a or the over-lay resin 20a and then is adhered to or enclosed by the melt melamine powder/particles 10a or the over-lay resin 20a. Yet on the finished melamine utensil 1, the wood part 30 can still be distinguished. Thus after hot pressing, the color or shape of the wood and/or similar materials 30a is shown on appearance of the melamine utensil 1. Both added value and decorative effect of the melamine utensil 1 are improved. Conventional melamine utensils and the manufacturing method thereof can't achieve such kind of effects.

The wood and/or similar materials such as bamboo powder or flakes 30a can be scarp material after general wood processing such as powder flakes from wood or bamboo processing factories or furniture factories. Not only waste material is recycled, but the amount of melamine powder/particles 10a used in the melamine utensil 1 is also reduced. Moreover, the wood and/or similar materials 30a is mixed with the melt melamine powder/particles 10a or the over-lay resin 20a during the hot pressing process so that the strength of the melamine utensil 1 is improved due to wood characters. Thus the melamine utensil 1 made by the present invention is not as fragile as prior arts.

The weight ratio of the melamine powder/particles 10a that form the melamine primary material 10, the over-lay resin 20a that forms the over-lay resin primary material 20 and the wood and/or similar materials 30a that form the wood part 30 is adjustable in accordance with the users requirements. For example, the melamine powder/particles 10a ranges from 25% to 40%, the wood and/or similar materials 30a is from 25% to 40% while the over-lay resin 20a is from 20% to 50%. The main reason to use certain amount (20%˜50%) of over-lay resin is to make the wood and/or similar materials 30a adhered to or enclosed by integrated melamine powder/particles 10a and the over-lay resin 20a. Thus the shortcoming of easy peeling or crack caused by poor connectivity between the wood and/or similar materials 30a and the melamine powder/particles 10a is overcome.

There is no limit on color or shape of the wood and/or similar materials 30a. They may particles with different sizes or irregular chips with different colors. The color of the wood and/or similar materials 30a may be brown, deep brown, light brown, or khaki, depending on color of original wood or bamboo. Besides colors, the amount of the wood and/or similar materials 30a being used such as 40%˜25% also have effect on the ratio or depth of color of the wood part 30 shown on surface of the melamine utensil 1. Therefore, there are various kinds of color that can be adjusted and chosen.

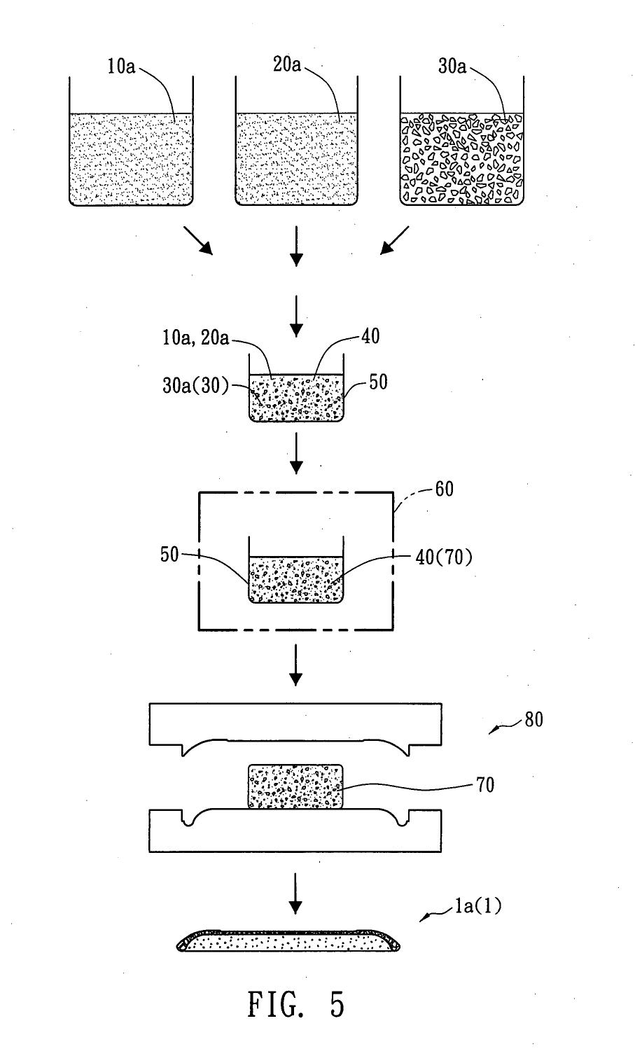

Refer to FIG. 5, a manufacturing process according to the present invention includes following steps:

step (1): providing the melamine powder/particles 10a, the over-lay resin 20a, and the wood and/or similar materials (such as bamboo) 30a;
step (2): mixing the melamine powder/particles 10a, the over-lay resin 20a, and the wood and/or similar material 30a in a certain ratio to compose a certain amount of composite material 40 and then the composite material 30 is set into a container 50 such as a cylinder; the amount of the composite material 40 depends on net weight of the melamine utensil 1;
step (3): putting the container 50 with the composite material 40 into a heater 60 (such as oven) at the temperature of 40 degrees Celsius for preheating so as to make powder/particles of the composite material 40 melt into a soft green compact 70;
step (4): mounting the soft green compact 70 into a mold 80 (male/female mold) in a hot pressing machine for being hot pressed and the temperature of the mold 80 is about 180 degrees Celsius;
step (5): taking the molded melamine utensil 1a from the mold 80, cooling, trimming (removing flash on edges) to form a finished melamine utensil 1.

The step (3), step (4) & step (5) are similar to some steps on manufacturing process of conventional melamine utensils. Yet the manufacturing process according to the present invention increases a preparing process-step (2) before the step (3) preheating to form a soft green compact 70. The main purpose of the step (2) is to make the wood and/or similar material 30a distribute uniformly in the melamine powder/particles 10a and the over-lay resin 20a. Once the wood and/or similar material 30a is not uniformly distributed inside the melamine powder/particles 10a and the over-lay resin 20a, the melamine powder/particles 10a and the over-lay resin 20a can't adhere or enclose the wood and/or similar material 30a firmly during the hot pressing process so that peeling or crack may happen due to poor connectivity between the wood and/or similar material 30a and the melamine powder/particles 10a/the over-lay resin 20a.

The preparing process of the step (2) includes different ways such as mixing or surface paving. Take certain amount of melamine powder/particles 10a the over-lay resin 20a and the wood and/or similar material 30a, then mix them well by a blender. Pour the mixture into a container 50 for running the step (3). By surface paving, certain amount of the wood and/or similar material 30a is covered on top or bottom surface of the melamine powder/particles 10a and the over-lay resin 20a in the container 50. The wood and/or similar material 30a can be partially or fully paved on the surface of the melamine powder/particles 10a and the over-lay resin 20a in the container 50 so as to make various patterns of the wood and/or similar material 30a shown on the melamine utensil 1.

What is claimed is:

1. A melamine utensil made by a hot pressing process comprising a melamine primary material, an over-lay resin primary material and a plurality of wood parts, wherein
the melamine primary material is formed by melamine powder/particles through the hot pressing process; during the hot pressing process, the melamine powder/particles are melt and integrated with over-lay resin to form a mixture that adheres or encloses the plurality of wood parts;
the over-lay resin primary material is formed by the over-lay resin going through the hot pressing process; during the hot pressing process, the over-lay resin is melt and integrated with the melamine powder/particles to form a mixture that adheres or encloses the plurality of wood parts; and
the wood part is formed by hot-pressed wood and/or similar materials and color or shape of the wood part is shown on surface of the melamine utensil by the hot pressing process.

2. The melamine utensil claimed as claim 1, wherein the similar materials comprising bamboo.

3. The melamine utensil claimed as claim 1, wherein the wood and/or similar materials comprising irregular wood chips with different sizes after being processed.

4. A manufacturing method of melamine utensils comprising the steps of:
providing melamine powder/particles, over-lay resin and wood and/or similar materials;
mixing the melamine powder/particles, the over-lay resin and the wood and/or similar materials in a certain ratio to form a certain amount of composite material that is put into a container;
putting the container with composite material into a heater for preheating so as to heat the composite material into a soft green compact;
putting the soft green compact into a mold of utensils for being hot pressed; and
releasing the shaped melamine utensil from the mold, through cooling and trimming processes to form a finished melamine utensil.

5. The manufacturing method of melamine utensils as claimed in claim 4, wherein the composite material having melamine powder/particles ranging from 25 to 40 weight percent, the over-lay resin ranging from 20 to 50 weight percent and the wood and/or similar materials ranging from 25 to 40 weight percent.

6. The manufacturing method of melamine utensils as claimed in claim 4, wherein the melamine powder/particles, the over-lay resin and the wood and/or similar materials are mixed into a uniform composite material that is put into the container.

7. The manufacturing method of melamine utensils as claimed in claim 4, wherein in the step of mixing the melamine powder/particles, the over-lay resin and the wood and/or similar materials to form composite material, the wood and/or similar materials is paved on top or bottom of the melamine powder/particles and the over-lay resin in the container.
